(19) United States
(12) Patent Application Publication
(10) Pub. No.: US 2008/0151390 A1
(43) Pub. Date: Jun. 26, 2008

(54) Auto-focusing image-forming lens set

(75) Inventor: Hung-Chih Li, Taichung City (TW)

Correspondence Address: BROWDY AND NEIMARK, P.L.L.C.;624 NINTH STREET, NW, SUITE 300, WASHINGTON, DC, 20001-5303, US

(73) Assignee: Genius Electronic Optical Co., Ltd., Taichung (TW)

(21) Appl. No.: 11/699,010

(22) Filed: Jan. 29, 2007

(30) Foreign Application Priority Data
Dec. 22, 2006 (TW) 95222692

(51) Int. Cl. G02B 1/11; G02B 3/00

(52) U.S. Cl. 359/722; 359/793

(57) ABSTRACT

An auto-focusing image-forming lens set, which includes a first optical system, a second optical system and an image forming face arranged in line along an optical axis. The first optical system has a predetermined number of convex lenses arranged along the optical axis, and defines with image forming face a fixed distance. The second optical system has one convex lens arranged on the optical axis and movable along the optical axis by a low-power driving source to change the distance between the second optical system and the image forming face and to automatically adjust the focus

### BACKGROUND OF THE INVENTION

1. Field of the Invention

The present invention relates image-forming lenses and more particularly, to an auto-focusing image-forming lens set.

2. Description of the Related Art

Following fast development of digital image-forming technology, digital camera lenses have been widely applied to different fields. For example, digital image-forming lenses are intensively used in cell phones, PDAs, personal computers, and many other electronic devices for picking up images.

Following image processing technology development of image sensors (CCD, CMOS), providing digital image-forming lens assemblies that have small, light, auto-focusing characteristics has become the major subject to be achieved at the present time. A regular digital image-forming lens structure with auto-focusing function generally comprises 2˜4 lenses, an optical filter, and a driving source for moving the lenses and the optical filter relative to the image sensor (CCD or CMOS) to achieve the function of auto-focusing. However, because the driving source needs to move 2˜4 lenses and one optical filter, it requires a relatively greater driving power. However, a big size and heavy weight come after high power, imparting a barrier to the demand for a small-sized and light-weighed design.

### SUMMARY OF THE INVENTION

The present invention has been accomplished under the circumstances in view. It is one object of the present invention to provide an auto-focusing image-forming lens set that is small-sized.

To achieve this and other objects of the present invention, the auto-focusing image-forming lens set comprises a first optical system, a second optical system and an image forming face arranged in line along an optical axis. The first optical system comprises a predetermined number of convex lenses arranged along the optical axis. The first optical system defines with the image forming face a fixed distance. The second optical system comprises at least one convex lens arranged on the optical axis. The second optical system is movable along the optical axis to change the distance between the second optical system and the image forming face, achieving auto-focusing.

### BRIEF DESCRIPTION OF THE DRAWING

FIG. 1 is a schematic drawing showing one arrangement of an auto-focusing image-forming lens set according to the present invention.

FIG. 2 is a schematic drawing showing another arrangement of the auto-focusing image-forming lens set according to the present invention.

### DETAILED DESCRIPTION OF THE INVENTION

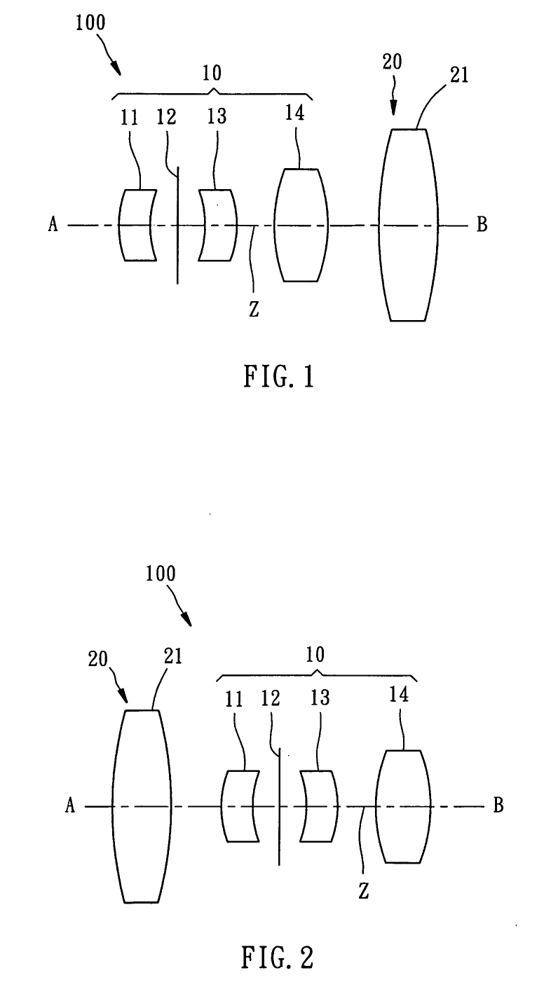

Referring to FIG. 1, an auto-focusing image-forming lens set 100 in accordance with the present invention is shown comprising a first optical system 10 and a second optical system 20.

The first optical system 10 and the second optical system 20 are arranged in line between the objective side A and an image forming side, i.e., image sensor (CCD or CMOS) B along an optical axis Z.

The first optical system 10 comprises a first lens 11, a diaphragm 12, a second lens 13, and a third lens 14. The first lens 11 is a convex lens having a negative diopter. The second lens 13 is a convex lens having a positive diopter. The diaphragm 12 is spaced between the first lens 11 and the second lens 13.

The second optical system 20 comprises a first lens 21 spaced between the first optical system 10 and the image forming side B. The first lens 21 of the second optical system 20 is a convex lens made out of a plastic or glass material. The surface of each of the two opposite sides of the first lens 21 of the second optical system 20 can be a spherical or non-spherical surface, providing a diopter.

The surface of the first lens 21 of the second optical system 20 that faces the objective side A can be coated with a layer of optical anti-reflection thin film to enhance transmission so as to obtain a better image forming effect.

The surface of the first lens 21 of the second optical system 20 that faces the image forming side B can be coated with a layer of optical thin film having a color filtration function to interfere with or absorb wavelength that is not sensible to human eyes, thereby reducing spurious signals and improving the image quality.

The aforesaid auto-focusing image-forming lens set satisfies the following conditions:

0<|1/F1|

in which:

F1: the focal distance of the first lens 21 of the second optical system 20.

Thus, when the distance between the objective side A and the auto-focusing image-forming lens set 100 is changed, the first lens 21 of the second optical system 20 is moved along the optical axis Z between the first optical system 10 and the image forming side B to alter the distance between the first lens 21 of the second optical system 20 and the image forming side B, so as to automatically adjust the focus for enabling the incident light to be focused onto the image forming side B accurately. Therefore, the invention achieves an auto-focusing effect simply by means of moving the second optical system 20 between the first optical system 10 and the image forming side B along the optical axis Z, i.e., the driving source (not shown) simply needs to move the second optical system 20 that has a less number of lens when adjusting the focus. Because less power is needed to drive the second optical system 20, the invention can use a small driving source to reduce the size of the whole structure, achieving the object of small-sized design.

According to the aforesaid embodiment, the first optical system 10 is comprised of three lenses, namely, the first lens 11, the second lens 13 and the third lens 14, and one diaphragm 12. Alternatively, the first optical system 10 can be formed of one single lens or two lenses, and any other lens combinations.

Further, as shown in FIG. 2, the second optical system 20 can be set between the first optical system 10 and the objective side A, and movable between the first optical system 10 and the objective side to alter the distance between the second optical system 20 and the image forming side B and to further adjust the focal distance.

Although a particular embodiment of the invention has been described in detail for purposes of illustration, various modifications and enhancements may be made without departing from the spirit and scope of the invention. Accordingly, the invention is not to be limited except as by the appended claims

What is claimed is:

1. An auto-focusing image-forming lens set comprising a first optical system, a second optical system and an image forming face arranged in line along an optical axis, wherein:
said first optical system comprises a predetermined number of convex lenses arranged along said optical axis, said first optical system defining with said image forming face a fixed distance;
said second optical system comprises at least one convex lens arranged on said optical axis, said second optical system being movable along said optical axis to change the distance between said second optical system and said image forming face.

2. The auto-focusing image-forming lens set as claimed in claim 1, wherein said second optical system is spaced between said first optical system and said image forming face.

3. The auto-focusing image-forming lens set as claimed in claim 1, wherein said first optical system is spaced between said second optical system and said image forming face.

4. The auto-focusing image-forming lens set as claimed in claim 1, wherein the at least one convex lens of said second optical system each is made out of a plastic material.

5. The auto-focusing image-forming lens set as claimed in claim 1, wherein the at least one convex lens of said second optical system each is made out of a glass material.

6. The auto-focusing image-forming lens set as claimed in claim 1, wherein the at least one convex lens of said second optical system each has a spherical surface.

7. The auto-focusing image-forming lens set as claimed in claim 1, the at least one convex lens of said second optical system each has a non-spherical surface.

8. The auto-focusing image-forming lens set as claimed in claim 1, wherein the at least one convex lens of said second optical system each is coated with a layer of optical anti-reflection thin film to enhance transmission.

9. The auto-focusing image-forming lens set as claimed in claim 1, wherein the at least one convex lens of said second optical system each is coated with a layer of optical thin film having a color filtration function to interfere with/absorb wavelength that is not sensible to human eyes.

10. The auto-focusing image-forming lens set as claimed in claim 1, which satisfies the condition of
0<|1/F1|

in which:
F1: the focal distance of the at least one convex lens of said second optical system.

11. The auto-focusing image-forming lens set as claimed in claim 1, wherein the at least one convex lens of said second optical system has a spherical surface and a non-spherical surface opposite to the spherical surface.

12. The auto-focusing image-forming lens set as claimed in claim 1, wherein the at least one convex lens of said second optical system has two opposite surfaces which are respectively coated with a layer of optical anti-reflection thin film to enhance transmission and a layer of optical thin film having a color filtration function.
